(19) United States
(12) Patent Application Publication
(10) Pub. No.: US 2025/0181923 A1
(43) Pub. Date: Jun. 5, 2025

(54) SYSTEMS AND METHODS FOR UTILIZING GENERATIVE ARTIFICIAL INTELLIGENCE TECHNIQUES TO CORRECT TRAINING DATA CLASS IMBALANCE AND IMPROVE PREDICTIONS OF MACHINE LEARNING MODELS

(71) Applicant: Verizon Patent and Licensing Inc., Basking Ridge, NJ (US)

(72) Inventors: Srinivasarao VALLURU, Hyderabad (IN); Chandrasekhar RANGU, Hyderabad (IN); Dhanraj J. NAIR, Flower Mound, TX (US); Apparao KODAVANTI, Hyderabad (IN); Sarathchandra KONIDENA, Hyderabad (IN)

(73) Assignee: Verizon Patent and Licensing Inc., Basking Ridge, NJ (US)

(21) Appl. No.: 18/527,913

(22) Filed: Dec. 4, 2023

(51) Int. Cl. G06N 3/088; G06N 3/0455

(52) U.S. Cl. CPC G06N 3/088; G06N 3/0455

(57) ABSTRACT

A device may receive first data associated with a first class and second data associated with a second class that is different than the first class, and may process the first data, with a generative adversarial network model, to generate synthetic data. The device may train a variational autoencoder (VAE) model using the second data, to generate a trained VAE model, and may utilize the first data, the second data, and the synthetic data with the trained VAE model to generate anomaly scores. The device may combine the anomaly scores with the first data, the second data, and the synthetic data to generate final data, and may train a machine learning model with the final data to generate a trained machine learning model. The device may perform one or more actions based on the trained machine learning model.

### BACKGROUND

Generative artificial intelligence is a subfield of artificial intelligence (AI) that involves creating models that can generate new data, such as text, images, audio, video, and/or the like. The technology industry is leveraging generative artificial intelligence in different domains to solve unaddressed problems and to improve efficiency in existing process flows.

### BRIEF DESCRIPTION OF THE DRAWINGS

FIGS. 1A-1G are diagrams of an example associated with utilizing generative artificial intelligence techniques to correct training data class imbalance.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing generative artificial intelligence techniques to correct training data class imbalance.

### DETAILED DESCRIPTION OF EXAMPLE EMBODIMENTS

The following detailed description of example implementations refers to the accompanying drawings. The same reference numbers in different drawings may identify the same or similar elements.

A machine learning (ML) model attempts to learn patterns from historical training data and to predict results. The predictive power of such a machine learning model is generally improved as the amount of historical training data used to train the model increases. However, when a new pattern is observed (e.g., a pattern that was not observed during a training phase of the model), the machine learning model may generate poor predictions. The historical training data used to train ML models (e.g., supervised ML models) may include different classes of data, e.g., a first class of data identifying fraudulent activities and a second class of data identifying non-fraudulent activities, though other and more classes are contemplated herein. A class imbalance occurs when a sample size of the first class of data is less than a sample size of the second class of data. If there are multiple classes of data, if any classes have significantly less or more data than others, this also indicates a class imbalance. If the machine learning model is trained on these imbalanced classes, the machine learning model may not properly learn patterns associated with the first class of data. Supervised machine learning problems may be associated with such class imbalances. For example, a machine learning model for fraud detection may be trained with less training data associated with fraudulent activities than training data associated with non-fraudulent activities because non-fraudulent data is more generally available as non-fraudulent activity is still more prevalent than fraudulent activity. There are known techniques to under-sample a majority class of training data and/or to over-sample a minority class of training data to address a class imbalance between the majority class and the minority class. For example, a machine learning model may assign a higher weight to the minority class by penalizing the majority class during training of the machine learning model. However, such techniques are not foolproof and still fail to properly train the machine learning model. In other words, these known techniques have significant drawbacks and may still cause an ML model to give inaccurate predictions.

Thus, current techniques for handling class imbalance during training of a machine learning model consume computing resources (e.g., processing resources, memory resources, communication resources, and/or the like), networking resources, and/or other resources associated with failing to properly eliminate class imbalance during training of a machine learning model, generating an inaccurate machine learning model based on failing to properly eliminate class imbalance during training of the machine learning model, performing incorrect actions based on results generated by the inaccurate machine learning model, and/or the like.

Some implementations described herein provide a training system that utilizes generative artificial intelligence techniques to correct training data class imbalance. For example, the training system may receive first data associated with a first class and second data associated with a second class that is different than the first class, and may process the first data, with a generative adversarial network (GAN) model, to generate synthetic data. The training system may process the second data, with a variational autoencoder (VAE) model, to generate a trained VAE model, and may utilize the first data, the second data, and the synthetic data with the trained VAE model to generate anomaly scores. The training system may combine the anomaly scores with the first data, the second data, and the synthetic data to generate final data, and may train a machine learning model with the final data to generate a trained machine learning model. The training system may receive new data, and may process the new data, with the trained machine learning model, to generate a prediction of whether the new data is associated with the first class or the second class. The training system may perform one or more actions based on the prediction.

In this way, the training system utilizes generative artificial intelligence techniques to correct training data class imbalance. For example, the training system may utilize generative artificial intelligence modeling (e.g., GAN models) to address class imbalance in training data and to improve a prediction power of a machine learning model. The training system may provide a hybrid solution that is a combination of generative artificial intelligence techniques and machine learning techniques, and that provides a trained machine learning model capable of generating correct results. Thus, the training system may conserve computing resources, networking resources, and/or other resources that would have otherwise been consumed by failing to properly eliminate class imbalance during training of a machine learning model, generating an inaccurate machine learning model based on failing to properly eliminate class imbalance during training of the machine learning model, performing incorrect actions based on results generated by the inaccurate machine learning model, and/or the like.

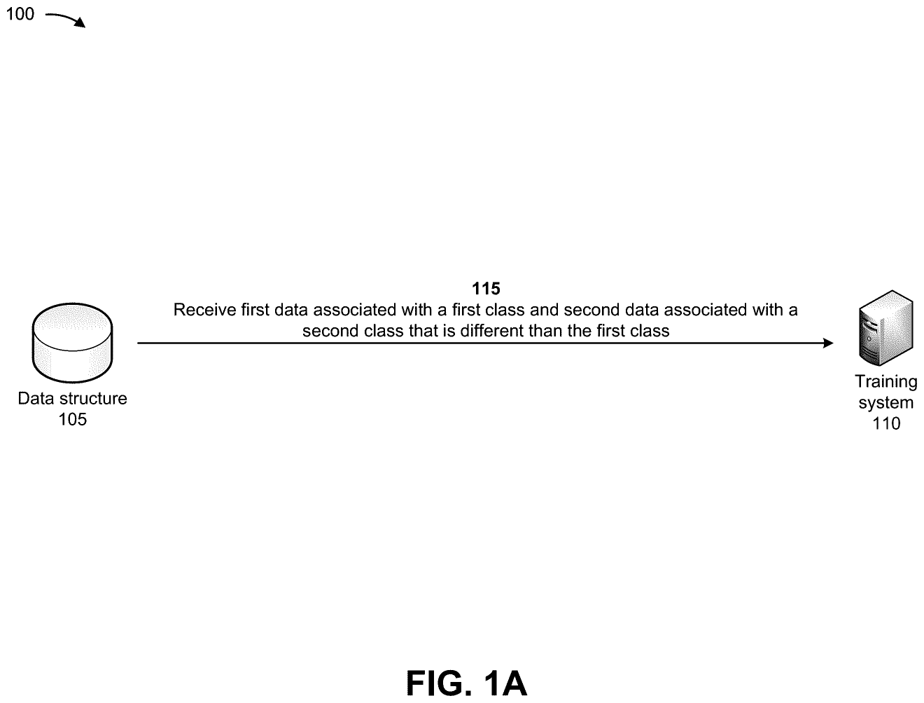

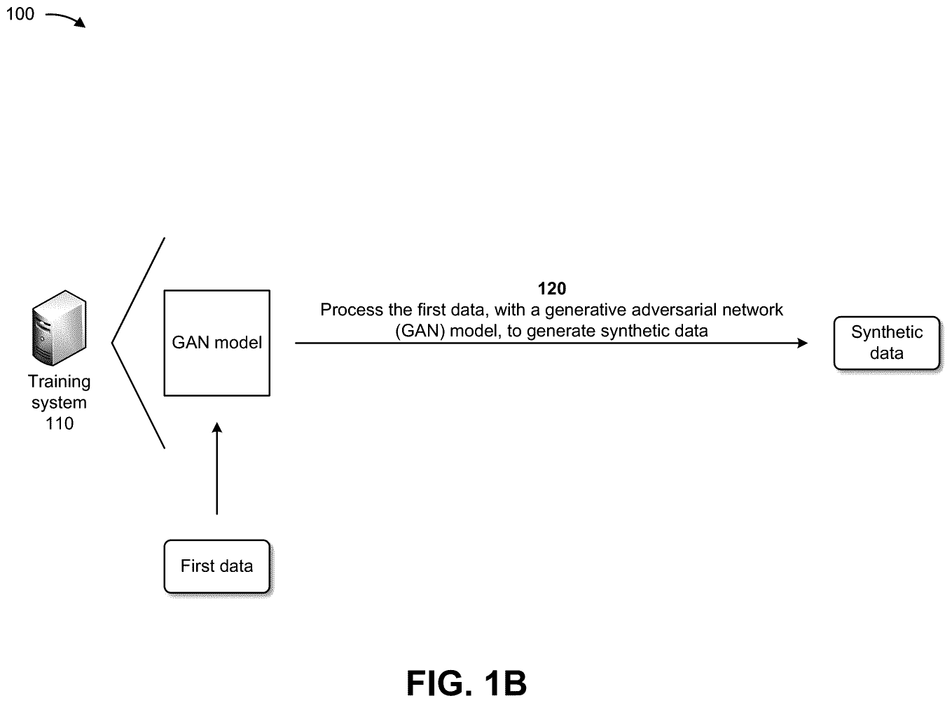

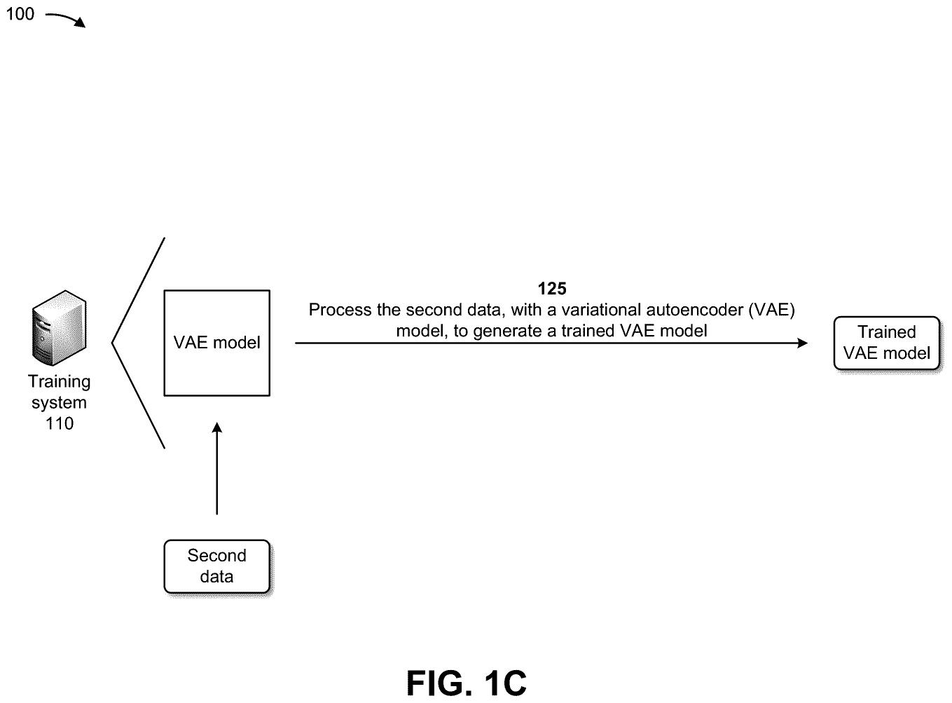

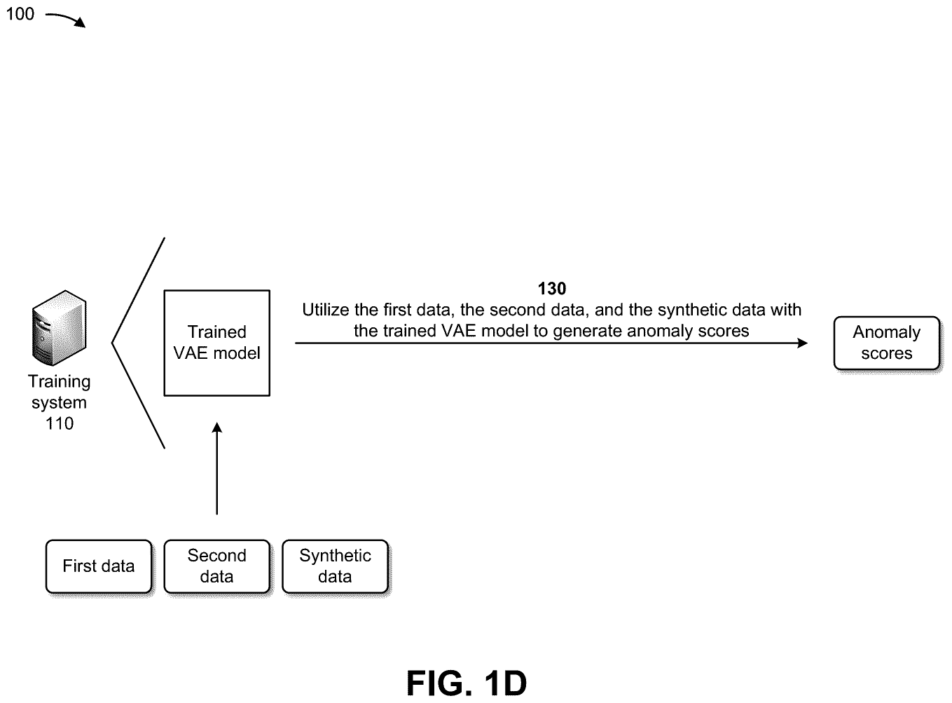

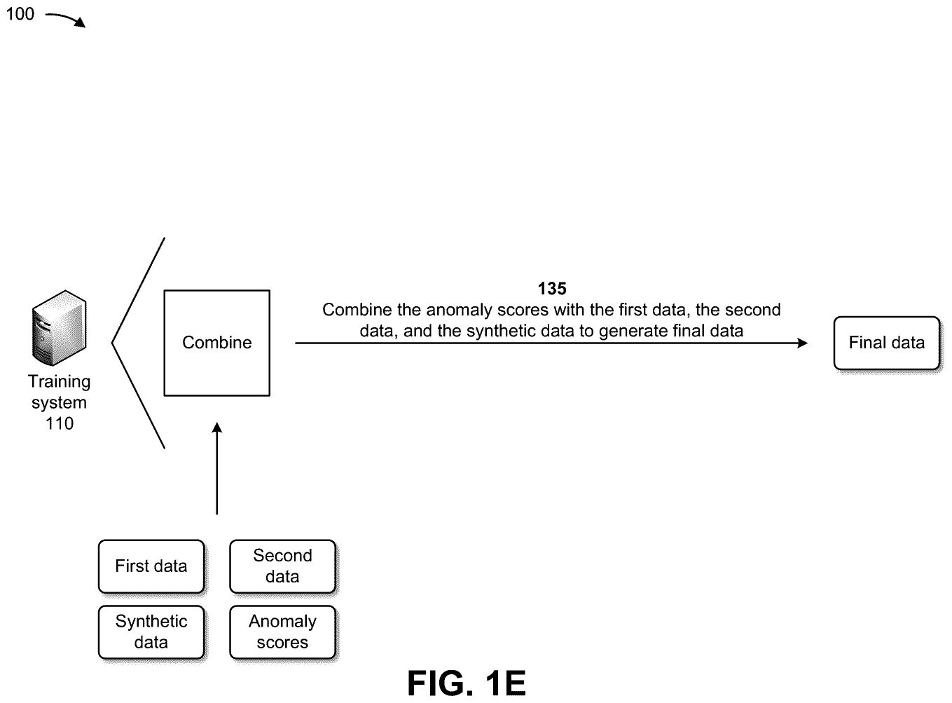

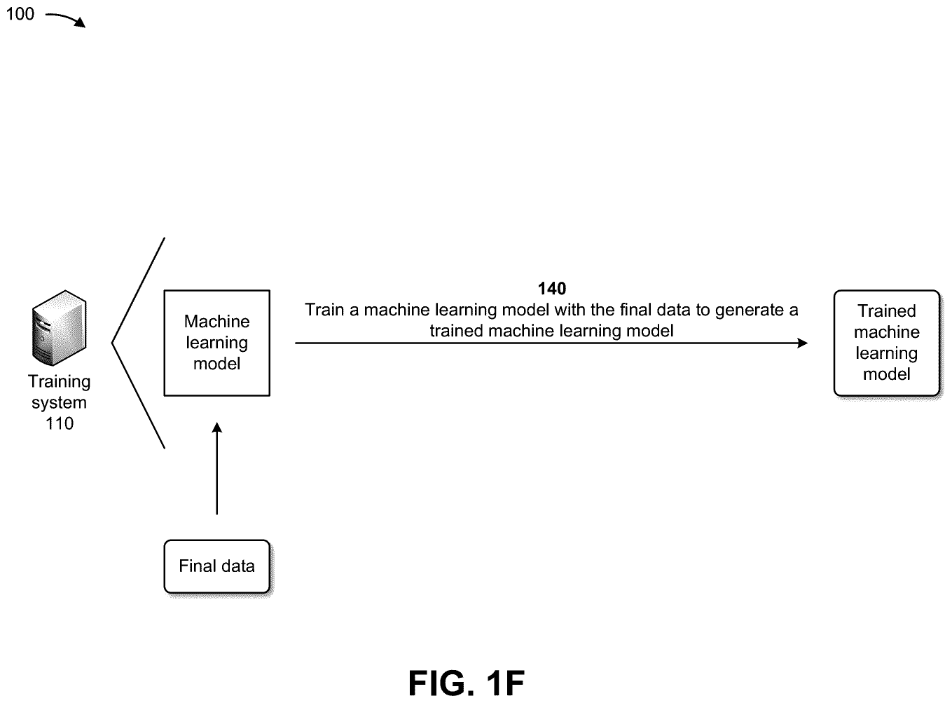

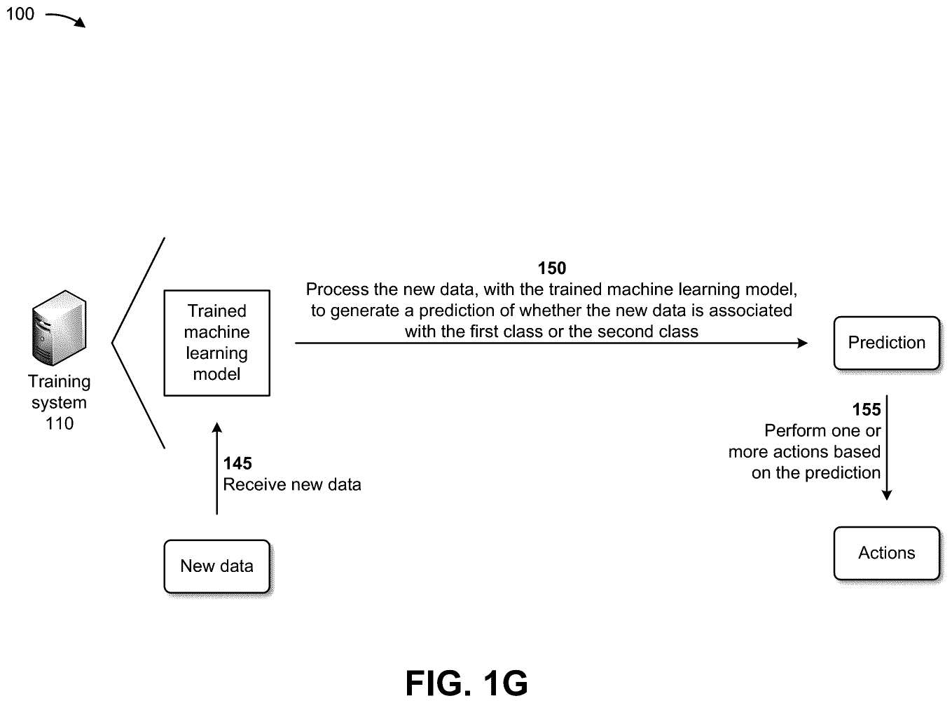

FIGS. 1A-1G are diagrams of an example 100 associated with utilizing generative artificial intelligence techniques to correct training data class imbalance. As shown in FIGS. 1A-1G, example 100 includes a data structure 105 associated with a training system 110. The data structure 105 may include a database, a table, a list, and/or the like that stores data. The training system 110 may include a system that utilizes generative artificial intelligence techniques to correct training data class imbalance. Further details of the data structure 105 and the training system 110 are provided elsewhere herein.

As shown in FIG. 1A, and by reference number 115, the training system 110 may receive first data associated with a first class and second data associated with a second class that is different than the first class. For example, the data structure 105 may receive and store the first data associated with the first class and the second data associated with the second class. In some implementations, the first data may include data associated with fraudulent activities and the second data may include data associated with non-fraudulent activities. For example, the fraudulent activities may include fraudulent activities associated with telecommunications products and services, such as Wangiri fraud (e.g., baiting a call from a customer to an expensive premium called number), short message service (SMS) phishing (e.g., sending repeated SMS messages to acquire personal information from a customer), subscriber identity module (SIM) jacking and SIM swapping (e.g., scammers take possession of a customer's SMS and calling access by swapping a phone number to another that they control), international revenue sharing fraud (IRSF) (e.g., misusing premium calls dialed by uninformed users causing hefting damages), interconnect bypass fraud (e.g., enabling fraudsters to pocket a difference in costs while forcing a customer to use inferior quality international calls), private branch exchange (PBX) hacking (e.g., permits fraudsters to control phone lines by manipulating unsecured phone networks), subscription fraud (e.g., when fraudsters sign up for services using misappropriated identifiers and pilfered credit card numbers), deposit fraud (e.g., credit card fraud and deposit fraud aimed at online stores using stolen credit card numbers), and/or the like. In some implementations, the non-fraudulent activities may include activities not classified as fraudulent activities, such as non-fraudulent activities associated with telecommunications products and services (e.g., placing calls, SMS services, Internet services, and/or the like).

In some implementations, the first data may include data associated with churn customers and the second data may include data associated with active customers in a churn prediction. The first data may include data associated with anomalies in network functionality and the second data may include data associated with normal network functionality in detecting the abnormal activity in the network. The first data may include data associated with network device failure and the second data may include data associated with normal functionality of the network device.

In some implementations, a quantity of the first data (e.g., a sample size of the first class of data, such as fraudulent data) may be less than a quantity of the second data (e.g., a sample size of the second class of data, such as non-fraudulent data). This may create a class imbalance between the first data and the second data, and a machine learning model may not properly learn patterns associated with the first data when the machine learning model is trained with the first data and the second data.

In some implementations, the training system 110 may continuously receive the first data associated with the first class and the second data associated with the second class from the data structure 105, may periodically receive the first data associated with the first class and the second data associated with the second class from the data structure 105, may receive the first data associated with the first class and the second data associated with the second class based on providing a request for the first data and the second data to the data structure 105, and/or the like.

As shown in FIG. 1B, and by reference number 120, the training system 110 may process the first data, with a GAN model, to generate synthetic data. For example, the training system 110 may be associated with GAN model. The GAN model may provide generative modeling using a deep learning model, such as a convolutional neural network model (e.g., a deep Convolutional GAN, a vanilla GAN, a conditional GAN (CGAN), a CycleGAN, a generative adversarial text-to-image synthesis, a style GAN, a super resolution GAN (SRGAN), and/or the like). The GAN model may include a generator (e.g., a neural network) and a discriminator (e.g., another neural network). The generator generates plausible data that becomes negative training examples for the discriminator. The discriminator learns to distinguish the generator's unrealistic data from real data, and penalizes the generator for producing implausible results. When training begins, the generator produces obviously fake data, and the discriminator quickly identifies the fake data. As training progresses, the generator gets closer to producing output that the discriminator cannot discern as “fake” data. Finally, the discriminator's ability to tell the difference between real data and fake data degrades, and the discriminator begins to classify fake data as real data. In other words, the accuracy of the discriminator decreases.

In some implementations, the training system 110 may utilize the GAN model to generate the synthetic data (e.g., synthetic first data, such as synthetic fraud data) based on the first data, which has a class imbalance with the second data. The GAN model may generate synthetic data that is realistic in nature since the synthetic data is generated based on learning distributions of patterns associated with the first data. In some implementations, a sum of a quantity of the synthetic data and the quantity of the first data may be substantially equivalent (e.g., within a percentage, such as one percent, five percent, ten percent, and/or the like) to the quantity of the second data in order to address the class imbalance between the first data and the second data.

As shown in FIG. 1C, and by reference number 125, the training system 110 may process the second data, with a VAE model, to generate a trained VAE model. For example, the training system 110 may be associated with a VAE model. The VAE model may include a probabilistic generative model with neural network components referred to as an encoder (or a first component) and a decoder (or a second component). The encoder maps an input variable to a latent space that corresponds to parameters of a variational distribution. In this way, the encoder can produce multiple different samples that all come from the same distribution. The decoder maps from the latent space to an input space in order to generate data points. The neural network component may be trained together with reparameterization (e.g., removing a random sample node from a backpropagation loop). The VAE model may be utilized for unsupervised learning, semi-supervised learning, and/or supervised learning.

In some implementations, the training system 110 may train the VAE model based on the second data and to generate the trained VAE model. The trained VAE model may understand patterns (e.g., non-fraudulent patterns) in the second data. The VAE model may include an encoder-decoder architecture, where the encoder may process input samples (e.g., the second data) and may provide results of processing the input samples to the decoder. The decoder may reconstruct the original input samples from the results received from the encoder. The VAE model may utilize an iterative process, and a goal of the VAE model during training may be to reduce anomaly scores (e.g., reconstruction errors) as much as possible and to reconstruct the original input samples. In some implementations, the VAE model may include a Kullback-Leibler (KL) divergence loss function configured to identify a data distribution of the second data. The KL divergence loss function may create, for the data distribution, a latent space with a mean and a standard deviation.

As shown in FIG. 1D, and by reference number 130, the training system 110 may utilize the first data, the second data, and the synthetic data with the trained VAE model to generate anomaly scores. For example, once the trained VAE model is generated, the training system 110 may process the first data, the second data, and the synthetic data, with the trained VAE model, to generate the anomaly scores (e.g., reconstruction errors). In some implementations, since the VAE model is trained with the second data (e.g., non-fraudulent data) alone, whenever new first data (e.g., fraud data) is processed by the trained VAE model, the trained VAE model generate a high anomaly score (e.g., a high reconstruction error) for the new first data. A range of anomaly scores generated by the trained VAE model for the first data may be greater than a range of anomaly scores generated by the trained VAE model for the second data. The variation in the ranges of the anomaly scores may provide a decision boundary for separating the first data (e.g., fraudulent activities) and the second data (e.g., non-fraudulent activities). In some implementations, the trained VAE model may generate a reconstruction error or an anomaly score for each sample of the first data, the second data, and the synthetic data. The anomaly scores may provide an additional feature to an original dataset (e.g., the first data and the second data).

As shown in FIG. 1E, and by reference number 135, the training system 110 may combine the anomaly scores with the first data, the second data, and the synthetic data to generate final data. For example, the training system 110 may determine a first set of anomaly scores for the first data, may determine a second set of anomaly scores for the second data, and may determine a third set of anomaly scores for the synthetic data. The training system 110 may combine the first set of anomaly scores with the first data to generate modified first data. The training system 110 may combine the second set of anomaly scores with the second data to generate modified second data. The training system 110 may combine the third set of anomaly scores with the synthetic data to generate modified synthetic data. The training system 110 may combine the modified first data, the modified second data, and the modified synthetic data to generate the final data.

As shown in FIG. 1F, and by reference number 140, the training system 110 may train a machine learning model with the final data to generate a trained machine learning model. For example, the machine learning model may include an XGBoost model, a multilayer perceptron model, a support vector machine model, and/or the like.

The XGBoost model minimizes a regularized (e.g., least absolute deviations and least square errors) objective function that combines a convex loss function (e.g., based on a difference between predicted and target outputs) and a penalty term for model complexity (e.g., regression tree functions). The multilayer perceptron model is a feed-forward neural network model with three layers: an input layer, a hidden layer, and an output layer. The input layer accepts a signal to be handled, and the output layer is responsible for functions like classification and prediction. An infinite series of hidden layers are located between the output layer and the input layer. Data passes in a forward path from the input layer to the output layer, equivalent to a network in feed-forward. A backpropagation learning technique may be used to train all of the nodes in the multilayer perceptron model.

The support vector machine model is a supervised learning model that analyzes data for classification and regression analysis. Given a set of training examples, each marked as belonging to one of two categories, a support vector machine may build a model that assigns new examples to one category or the other, making it a non-probabilistic binary linear classifier. The support vector machine model maps training examples to points in space so as to maximize a width of a gap between the two categories. New examples are then mapped into that same space and predicted to belong to a category based on which side of the gap they fall.

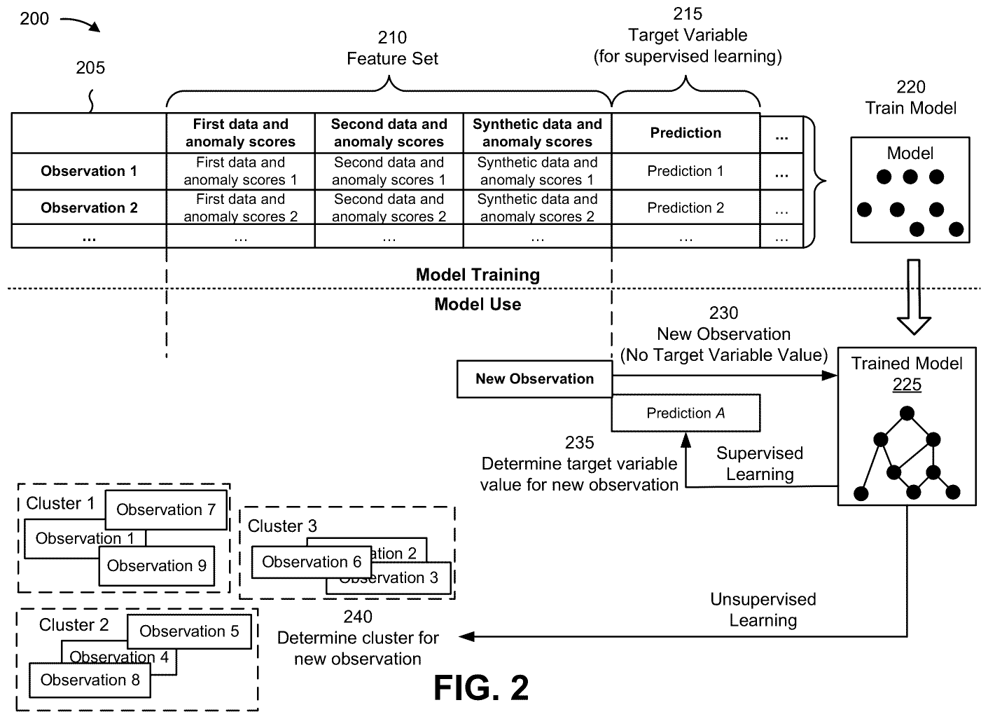

In some implementations, the training system 110 may utilize the final data as training data to train the machine learning model and to generate the trained machine learning model. The anomaly scores included in the final data may be highly correlated with the target variable (e.g., fraudulent or non-fraudulent) of the final data and may improve a prediction power of the machine learning model to decide a label for the new data. Further details of training and using a machine learning model are provided below in connection with FIG. 2.

In some implementations, the training system 110 may perform one or more actions based on the trained machine learning model, such as implement the trained machine learning model in a system associated with the first data and the second data. For example, the training system 110 may utilize the trained machine learning model to determine whether data associated with the system corresponds to the first class (e.g., fraudulent activities) or the second class (e.g., non-fraudulent activities). In this way, the training system 110 may conserve computing resources, networking resources, and/or other resources that would have otherwise been consumed by failing to properly eliminate class imbalance during training of a machine learning model.

As shown in FIG. 1G, and by reference number 145, the training system 110 may receive new data. For example, the training system 110 may implement the trained machine learning model in a system associated with the first data and the second data since the trained machine learning model addresses the class imbalance issue associated with the first data and the second data. In some implementations, the training system 110 may receive the new data from such a system. The new data may be associated with the first class (e.g., a fraudulent activity) or the second class (e.g., a non-fraudulent activity).

As further shown in FIG. 1G, and by reference number 150, the training system 110 may process the new data, with the trained machine learning model, to generate a prediction of whether the new data is associated with the first class or the second class. For example, the training system 110 may utilize the trained machine learning model to determine the prediction of whether the new data is associated with the first class or the second class. In some implementations, the training system 110 may determine a prediction that the new data is associated with the first class. Alternatively, the training system 110 may determine a prediction that the new data is associated with the second class.

In some implementations, the training system 110 may process the new data, with the trained VAE model, to generate anomaly scores. Once the anomaly scores are generated by the trained VAE model, the training system 110 may process the new data and the anomaly scores, with the trained machine learning model, to generate the prediction of whether the new data is associated with the first class or the second class.

As further shown in FIG. 1G, and by reference number 155, the training system 110 may perform one or more actions based on the prediction. In some implementations, performing the one or more actions includes the training system 110 providing the prediction for display. For example, the training system 110 may provide information identifying the prediction for display to a user of the training system 110. The user may utilize the prediction to perform an action associated with the new data, such as attempting to prevent fraud associated with the new data. In this way, the training system 110 may conserve computing resources, networking resources, and/or other resources that would have otherwise been consumed by generating an inaccurate machine learning model based on failing to properly eliminate class imbalance during training of the machine learning model.

In some implementations, performing the one or more actions includes the training system 110 determining non-fraudulent activity based on the prediction, predicting customer churn based on the prediction, detecting an anomaly (e.g., to prevent network or device failure) based on the prediction, providing automatic notifications of the prediction to concerned systems, and/or the like.

In some implementations, performing the one or more actions includes the training system 110 utilizing the prediction to make a decision associated with the new data. For example, the training system 110 may determine that the prediction indicates that a fraudulent activity is occurring. The training system 110 may take steps to prevent or minimize the fraudulent activity based on the prediction. In this way, the training system 110 may conserve computing resources, networking resources, and/or other resources that would have otherwise been consumed by performing incorrect actions based on results generated by the inaccurate machine learning model.

In some implementations, performing the one or more actions includes the training system 110 retraining the machine learning model based on the prediction. For example, the training system 110 may utilize the prediction as additional training data for retraining the machine learning model, thereby increasing the quantity of training data available for training the machine learning model. Accordingly, the training system 110 may conserve computing resources associated with identifying, obtaining, and/or generating historical data for training the machine learning model relative to other systems for identifying, obtaining, and/or generating historical data for training machine learning models.

In this way, the training system 110 utilizes generative artificial intelligence techniques to correct training data class imbalance. For example, the training system 110 may utilize generative artificial intelligence modeling (e.g., GAN models) to address class imbalance in training data and to improve a prediction power of a machine learning model. The training system 110 may provide a hybrid solution that is a combination of generative artificial intelligence techniques and machine learning techniques, and that provides a trained machine learning model capable of generating correct results. Thus, the training system 110 may conserve computing resources, networking resources, and/or other resources that would have otherwise been consumed by failing to properly eliminate class imbalance during training of a machine learning model, generating an inaccurate machine learning model based on failing to properly eliminate class imbalance during training of the machine learning model, performing incorrect actions based on results generated by the inaccurate machine learning model, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram illustrating an example 200 of training and using a machine learning model in connection with determining a prediction of whether new data is associated with a first class or a second class. The machine learning model training and usage described herein may be performed using a machine learning system. The machine learning system may include or may be included in a computing device, a server, a cloud computing environment, or the like, such as the training system 110 described in more detail elsewhere herein.

As shown by reference number 205, a machine learning model may be trained using a set of observations. The set of observations may be obtained from training data (e.g., historical data), such as data gathered during one or more processes described herein. In some implementations, the machine learning system may receive the set of observations (e.g., as input), as described elsewhere herein.

As shown by reference number 210, the set of observations may include a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on the input. For example, the machine learning system may identify a feature set (e.g., one or more features and/or feature values) by extracting the feature set from structured data, by performing natural language processing to extract the feature set from unstructured data, and/or by receiving input from an operator.

As an example, a feature set for a set of observations may include a first feature of first data (e.g., order and transaction details, network details, and/or the like) and anomaly scores (e.g., previously generated), a second feature of second data (e.g., order and transaction details, network details, and/or the like) and anomaly scores (e.g., previously generated), a third feature of synthetic data and anomaly scores (e.g., previously generated), and so on. As shown, for a first observation, the first feature may have a value of first data and anomaly scores 1, the second feature may have a value of second data and anomaly scores 1, the third feature may have a value of synthetic data and anomaly scores 1, and so on. These features and feature values are provided as examples, and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiples classes, classifications, or labels) and/or may represent a variable having a Boolean value. A target variable may be associated with a target variable value, and a target variable value may be specific to an observation. In example 200, the target variable is a prediction, which has a value of prediction 1 for the first observation. The feature set and target variable described above are provided as examples, and other examples may differ from what is described above.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. The new observation may be provided to the trained machine learning model 225 to generate an anomaly score. The machine learning system may apply the trained machine learning model 225 to the new observation and the anomaly score to generate an output (e.g., a result, such as a target prediction). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs and/or information that indicates a degree of similarity between the new observation and one or more other observations, such as when unsupervised learning is employed.

As an example, the trained machine learning model 225 may predict a value of prediction A for the target variable of the prediction for the new observation, as shown by reference number 235. Based on this prediction, the machine learning system may provide a first recommendation, may provide output for determination of a first recommendation, may perform a first automated action, and/or may cause a first automated action to be performed (e.g., by instructing another device to perform the automated action), among other examples.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a first data and anomaly scores cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a second data and anomaly scores cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification or categorization), may be based on whether a target variable value satisfies one or more threshold (e.g., whether the target variable value is greater than a threshold, is less than a threshold, is equal to a threshold, falls within a range of threshold values, or the like), and/or may be based on a cluster in which the new observation is classified. The recommendations, actions, and clusters described above are provided as examples, and other examples may differ from what is described above.

In some implementations, the trained machine learning model 225 may be re-trained using feedback information. For example, feedback may be provided to the machine learning model. The feedback may be associated with actions performed based on the recommendations provided by the trained machine learning model 225 and/or automated actions performed, or caused, by the trained machine learning model 225. In other words, the recommendations and/or actions output by the trained machine learning model 225 may be used as inputs to re-train the machine learning model (e.g., a feedback loop may be used to train and/or update the machine learning model).

In this way, the machine learning system may apply a rigorous and automated process to determine a prediction of whether new data is associated with a first class or a second class. The machine learning system may enable recognition and/or identification of tens, hundreds, thousands, or millions of features and/or feature values for tens, hundreds, thousands, or millions of observations, thereby increasing accuracy and consistency and reducing delay associated with determining a prediction of whether new data is associated with a first class or a second class relative to requiring computing resources to be allocated for tens, hundreds, or thousands of operators to manually determine a prediction of whether new data is associated with a first class or a second class.

As indicated above, FIG. 2 is provided is an example. Other examples may differ from what is described in connection with FIG. 2.

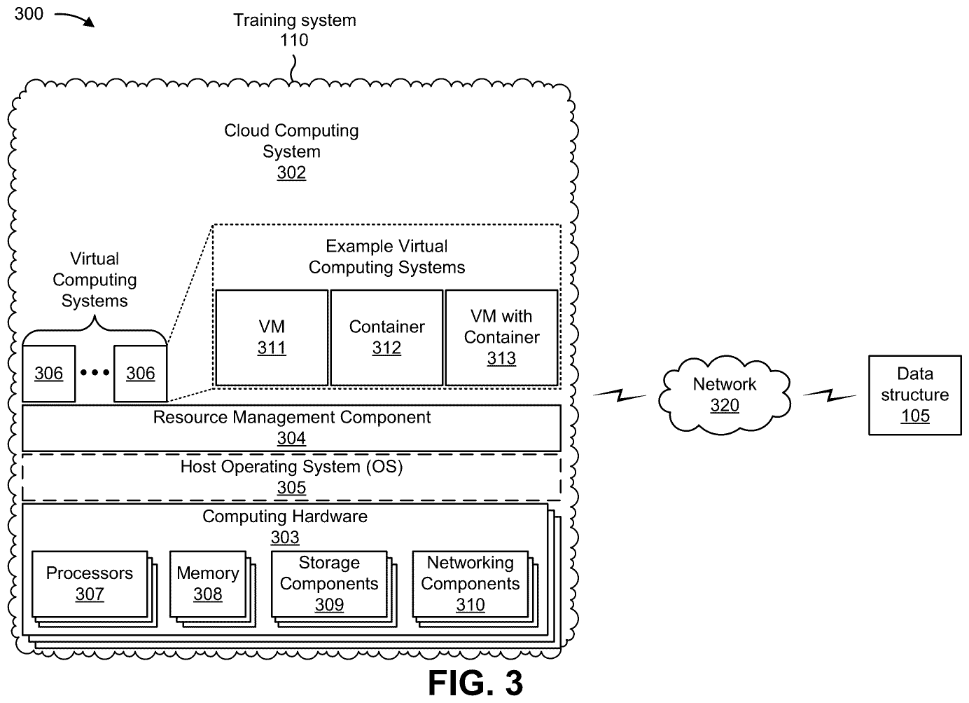

FIG. 3 is a diagram of an example environment 300 in which systems and/or methods described herein may be implemented. As shown in FIG. 3, the environment 300 may include the training system 110, which may include one or more elements of and/or may execute within a cloud computing system 302. The cloud computing system 302 may include one or more elements 303-313, as described in more detail below. As further shown in FIG. 3, the environment 300 may include the data structure 105 and/or a network 320. Devices and/or elements of the environment 300 may interconnect via wired connections and/or wireless connections.

The data structure 105 may include one or more devices capable of receiving, generating, storing, processing, and/or providing information, as described elsewhere herein. The data structure 105 may include a communication device and/or a computing device. For example, the data structure 105 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 105 may communicate with one or more other devices of the environment 300, as described elsewhere herein.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

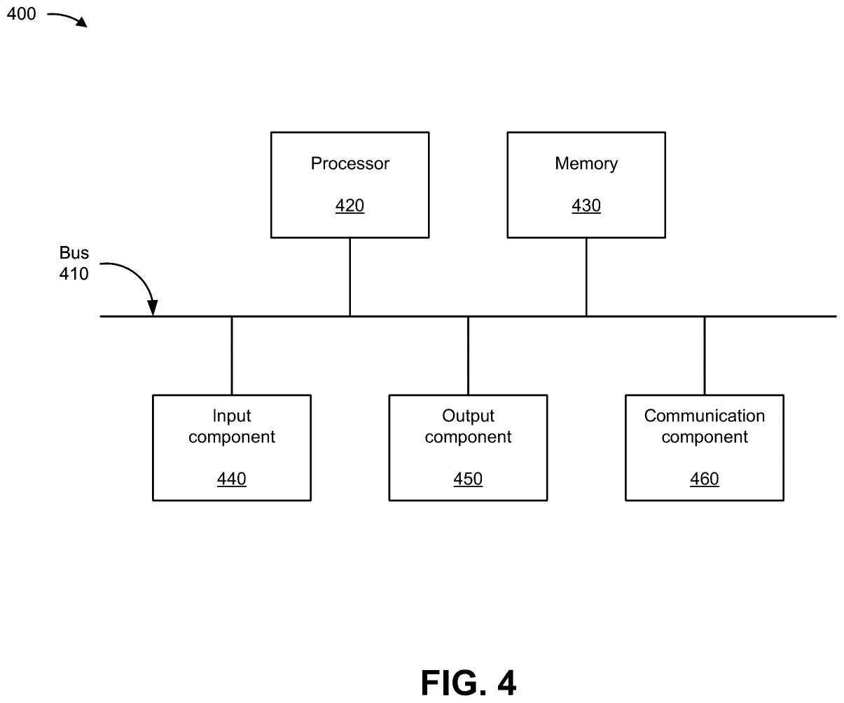

Although the training system 110 may include one or more elements 303-313 of the cloud computing system 302, may execute within the cloud computing system 302, and/or may be hosted within the cloud computing system 302, in some implementations, the training system 110 may not be cloud-based (e.g., may be implemented outside of a cloud computing system) or may be partially cloud-based. For example, the training system 110 may include one or more devices that are not part of the cloud computing system 302, such as the device 400 of FIG. 4, which may include a standalone server or another type of computing device. The training system 110 may perform one or more operations and/or processes described in more detail elsewhere herein.

The network 320 may include one or more wired and/or wireless networks. For example, the network 320 may include a cellular network (e.g., a 5G network, a 4G network, an LTE network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 320 enables communication among the devices of environment 300.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the data structure 105 and/or the training system 110. In some implementations, the data structure 105 and/or the training system 110 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

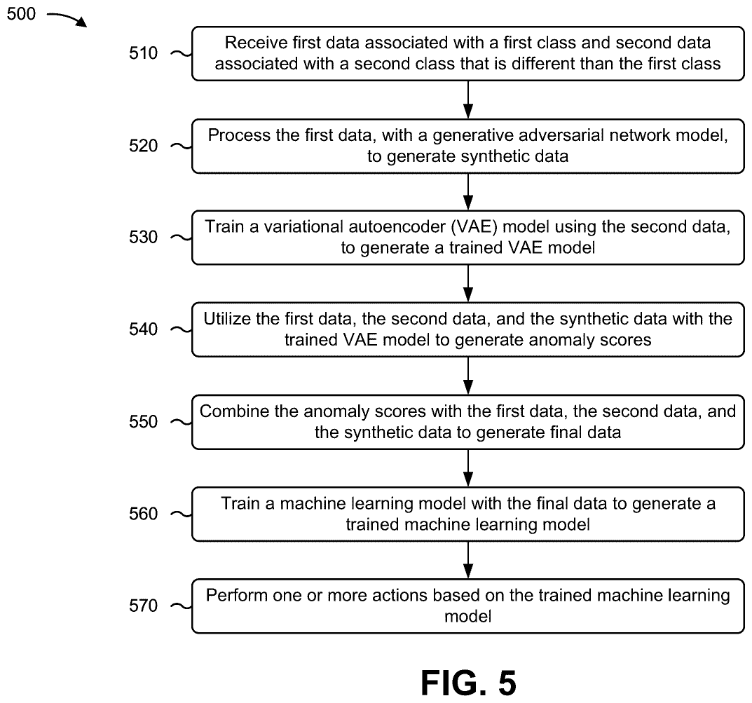

FIG. 5 is a flowchart of an example process 500 for utilizing generative artificial intelligence techniques to correct training data class imbalance. In some implementations, one or more process blocks of FIG. 5 may be performed by a device (e.g., the training system 110). In some implementations, one or more process blocks of FIG. 5 may be performed by another device or a group of devices separate from or including the device. Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving first data associated with a first class and second data associated with a second class that is different than the first class (block 510). For example, the device may receive first data associated with a first class and second data associated with a second class that is different than the first class, as described above. In some implementations, the first data is data associated with fraudulent activities and the second data is data associated with non-fraudulent activities.

As further shown in FIG. 5, process 500 may include processing the first data, with a GAN model, to generate synthetic data (block 520). For example, the device may process the first data, with a GAN model, to generate synthetic data, as described above. In some implementations, the synthetic data is generated based on learning a distribution of patterns associated with the first data. In some implementations, a sum of a quantity of the first data and a quantity of the synthetic data is substantially equivalent to a quantity of the second data.

As further shown in FIG. 5, process 500 may include training a VAE model using the second data, to generate a trained VAE model (block 530). For example, the device may train a VAE model using the second data, to generate a trained VAE model, as described above. In some implementations, the VAE model is an unsupervised neural network model. In some implementations, the trained VAE model includes an encoder-decoder architecture configured to reconstruct the first data, the second data, and the synthetic data, and a Kullback-Leibler divergence loss function configured to identify a data distribution of the second data.

As further shown in FIG. 5, process 500 may include utilizing the first data, the second data, and the synthetic data with the trained VAE model to generate anomaly scores (block 540). For example, the device may utilize the first data, the second data, and the synthetic data with the trained VAE model to generate anomaly scores, as described above. In some implementations, a range of anomaly scores associated with the first data is greater than a range of anomaly scores associated with the second data.

As further shown in FIG. 5, process 500 may include combining the anomaly scores with the first data, the second data, and the synthetic data to generate final data (block 550). For example, the device may combine the anomaly scores with the first data, the second data, and the synthetic data to generate final data, as described above. In some implementations, after combining the first data, the second data and the synthetic data, the device may provide the combined data to the trained VAE model to generate anomaly scores. The device may provide these anomaly scores as a feature to a machine learning model.

As further shown in FIG. 5, process 500 may include training a machine learning model with the final data to generate a trained machine learning model (block 560). For example, the device may train a machine learning model with the final data to generate a trained machine learning model, as described above. In some implementations, the machine learning model is one of an XGBoost model, a multilayer perceptron model, or a support vector machine model. In some implementations, the trained machine learning model addresses a class imbalance issue associated with the first data and the second data. In some implementations, the device may generate an anomaly score using the trained VAE model for new data and may pass the anomaly score to the trained machine learning model for prediction (e.g., of class, such as fraud or non-fraud).

As further shown in FIG. 5, process 500 may include performing one or more actions based on the trained machine learning model (block 570). For example, the device may perform one or more actions based on the trained machine learning model, as described above. In some implementations, performing the one or more actions based on the trained machine learning model includes implementing the trained machine learning model in a system associated with the first data and the second data.

In some implementations, process 500 includes receiving new data; processing the new data, with the trained machine learning model, to generate a prediction of whether the new data is associated with the first class or the second class; and performing one or more additional actions based on the prediction. In some implementations, performing the one or more additional actions includes retraining the machine learning model based on the prediction. In some implementations, performing the one or more additional actions includes one or more of providing the prediction for display, or utilizing the prediction to make a decision associated with the new data. In some implementations, performing the one or more additional actions includes determining non-fraudulent activity based on the prediction, predicting customer churn based on the prediction, detecting an anomaly (e.g., to prevent network or device failure) based on the prediction, providing automatic notifications of the prediction to concerned systems, and/or the like.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, first data associated with a first class and second data associated with a second class that is different than the first class;
processing, by the device, the first data, with a generative adversarial network model, to generate synthetic data;
training, by the device, a variational autoencoder (VAE) model using the second data, to generate a trained VAE model;
utilizing, by the device, the first data, the second data, and the synthetic data with the trained VAE model to generate anomaly scores;
combining, by the device, the anomaly scores with the first data, the second data, and the synthetic data to generate final data;
training, by the device, a machine learning model with the final data to generate a trained machine learning model; and
performing, by the device, one or more actions based on the trained machine learning model.

2. The method of claim 1, further comprising:
receiving new data;
processing the new data, with the trained machine learning model, to generate a prediction of whether the new data is associated with the first class or the second class; and
performing one or more additional actions based on the prediction.

3. The method of claim 2, wherein performing the one or more additional actions comprises:
retraining the machine learning model based on the prediction.

4. The method of claim 2, wherein performing the one or more additional actions comprises one or more of:
generating a whitelist or a blacklist based on the prediction;
determining fraudulent activity based on the prediction; or
utilizing the prediction to make a decision associated with the new data.

5. The method of claim 1, wherein the synthetic data is generated based on learning a distribution of patterns associated with the first data.

6. The method of claim 1, wherein a sum of a quantity of the first data and a quantity of the synthetic data is substantially equivalent to a quantity of the second data.

7. The method of claim 1, wherein the first data is data associated with fraudulent activities and the second data is data associated with non-fraudulent activities.

8. A device, comprising:
one or more processors configured to:
receive first data associated with a first class and second data associated with a second class that is different than the first class;
process the first data, with a generative adversarial network model, to generate synthetic data;
process the second data, with a variational autoencoder (VAE) model, to generate a trained VAE model;
utilize the first data, the second data, and the synthetic data with the trained VAE model to generate anomaly scores;
combine the anomaly scores with the first data, the second data, and the synthetic data to generate final data;
train a machine learning model with the final data to generate a trained machine learning model;
perform one or more actions based on the trained machine learning model;
receive new data;
process the new data, with the trained VAE model, to generate a risk score;
process the new data and the risk score, with the trained machine learning model, to generate a prediction of whether the new data is associated with the first class or the second class; and
perform one or more additional actions based on the prediction.

9. The device of claim 8, wherein the VAE model is an unsupervised neural network model.

10. The device of claim 8, wherein the trained VAE model includes an encoder-decoder architecture configured to reconstruct the first data, the second data, and the synthetic data, and a Kullback-Leibler divergence loss function configured to identify a data distribution of the second data.

11. The device of claim 8, wherein a range of anomaly scores associated with the first data is greater than a range of anomaly scores associated with the second data.

12. The device of claim 8, wherein the one or more processors, to perform the one or more actions based on the trained machine learning model, are configured to:
implement the trained machine learning model in a system associated with the first data and the second data.

13. The device of claim 8, wherein the machine learning model is one of an XGBoost model, a multilayer perceptron model, or a support vector machine model.

14. The device of claim 8, wherein the trained machine learning model addresses a class imbalance issue associated with the first data and the second data.

15. A non-transitory computer-readable medium storing a set of instructions, the set of instructions comprising:
one or more instructions that, when executed by one or more processors of a device, cause the device to:
receive first data associated with a first class and second data associated with a second class that is different than the first class;
process the first data, with a generative adversarial network model, to generate synthetic data;
process the second data, with a variational autoencoder (VAE) model, to generate a trained VAE model;
utilize the first data, the second data, and the synthetic data with the trained VAE model to generate anomaly scores;
combine the anomaly scores with the first data, the second data, and the synthetic data to generate final data;
train a machine learning model with the final data to generate a trained machine learning model;
receive new data;
process the new data and an anomaly score prediction for the new data, with the trained machine learning model, to generate a prediction of whether the new data is associated with the first class or the second class; and
perform one or more actions based on the prediction.

16. The non-transitory computer-readable medium of claim 15, wherein the one or more instructions, that cause the device to perform the one or more actions, cause the device to one or more of:
retrain the machine learning model based on the prediction;
provide the prediction for display; or
utilize the prediction to make a decision associated with the new data.

17. The non-transitory computer-readable medium of claim 15, wherein the synthetic data is generated based on learning a distribution of patterns associated with the first data.

18. The non-transitory computer-readable medium of claim 15, wherein a sum of a quantity of the first data and a quantity of the synthetic data is substantially equivalent to a quantity of the second data.

19. The non-transitory computer-readable medium of claim 15, wherein the first data is data associated with fraudulent activities and the second data is data associated with non-fraudulent activities.

20. The non-transitory computer-readable medium of claim 15, wherein the trained VAE model includes an encoder-decoder architecture configured to reconstruct the first data, the second data, and the synthetic data, and a Kullback-Leibler divergence loss function configured to identify a data distribution of the second data.
